(19) United States
(12) Patent Application Publication
(10) Pub. No.: US 2025/0362044 A1
(43) Pub. Date: Nov. 27, 2025

(54) METHODS AND SYSTEMS FOR DETERMINING FINANCIAL LOSSES IN HEATING, VENTILATION, AND AIR CONDITIONING (HVAC) SYSTEM

(71) Applicant: Honeywell International Inc., Charlotte, NC (US)

(72) Inventor: Zdenek Schindler, Praha (CZ)

(21) Appl. No.: 18/674,955

(22) Filed: May 27, 2024

(51) Int. Cl. G06Q 10/0639; G05B 15/02

(52) U.S. Cl. CPC F24F 11/46; G05B 15/02; G06Q 10/06393

(57) ABSTRACT

A method and system for determining financial losses in heating, ventilation, and air conditioning (HVAC) system are disclosed. The method comprises receiving, via at least one processor, a first set of data associated with a plurality of positions of one or more components of HVAC system, from one or more sensors, over a predefined time period; determining a second set of data associated with plurality of positions, based at least on predefined width constant (K); determining at least one real travel distance (Sᵣ) associated with plurality of positions based at least on first set of data; determining at least one baseline travel distance (S_{b}) associated with plurality of positions based at least on second set of data; and determining one or more Key Performance Indicator (KPI) values of one or more components based at least on the determined Sᵣ and S_{b}, that relate to lifespan loss and energy wasting.

### TECHNOLOGICAL FIELD

The present invention relates to heating, ventilation, and air conditioning (HVAC) system, and more particularly relates to a method and system for determining financial losses in the HVAC system due to unwanted oscillations.

### BACKGROUND

Heating, ventilation, and air conditioning (HVAC) system refers to the technology used to provide indoor comfort and maintain air quality in buildings, vehicles, and other enclosed spaces. The HVAC system provides heating by various means such as furnaces, boilers, heat pumps, municipal heating network through heat exchangers and electric heaters. Also, the HVAC system provides cooling of spaces needed in warm climates. In the HVAC system, it is often noticed that some HVAC subsystems such as valves, keep changing their settings or positions to compensate with disturbances (for example, changes of outdoor temperature) and adapt with a requirement of an end user. However, to compensate and adapt, the HVAC subsystems often carry excessive additional movements that are not required for compensating the disturbances and adapting to the requirement of the end user. Such excessive changes in the settings or positions, called oscillations enforce the HVAC system to consume more energy that further results in wear out of the HVAC subsystems faster and thus gradually require regular maintenance. Further, oscillations are excessive additional movements of parts, not needed for the desired function of the HVAC system. For example, oscillations may be related to fast opening and closing of valve instead of keeping some central position of the valve, which is sufficient for correct operation of the HVAC system. Therefore, the oscillations may enforce the end user to do maintenance more frequently than regular maintenance and thus results in increasing the overall cost. Typically, there are no solutions for the HVAC system that are able to determine or estimate additional cost required for these frequent maintenance. Further, there are no solutions provided for the HV AC system to determine how much shorter the life of the HVAC subsystems will be because of the extra wear and tear, and also how much energy is wasted because of the oscillations due to the fast changes in the positions of the HVAC subsystems.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In one example embodiment, a method is disclosed. The method comprising receiving, via at least one processor, a first set of data associated with a plurality of positions of one or more components of a Heating, Ventilation, and Air Conditioning (HVAC) system, from one or more sensors, over a predefined time period. Further, the method comprises determining, via the at least one processor, a second set of data associated with the plurality of positions of the one or more components of the HVAC system, based at least on a predefined width constant (K), in the predefined time period. Further, the method comprises determining, via the at least one processor, at least one real travel distance (Sᵣ) associated with the plurality of positions of the one or more components of the HVAC system in the predefined time period based at least on the first set of data. Further, the method comprises determining, via the at least one processor, at least one baseline travel distance (S_{b}) associated with the plurality of positions of the one or more components of the HVAC system in the predefined time period based at least on the second set of data. Thereafter, the method comprises determining, via the at least one processor, one or more Key Performance Indicator (KPI) values of the one or more components for the predefined time period based at least on the determined Sᵣ and S_{b}.

In some embodiments, the first set of data corresponds to a time series of historical data associated with the plurality of positions of the one or more components of the HVAC system. In some embodiments, the second set of data corresponds to a baseline time series data associated with the plurality of positions of the one or more components of the HVAC system.

In some embodiments, the one or more sensors comprises at least one of a limit switch sensor, potentiometers, encoders, hall effect sensors, proximity sensors, ultrasonic sensors, optical sensors, linear variable differential transformer (LVDT) sensors, and pressure sensors. In some embodiments, the predefined time period corresponds to a monitored time period comprising at least one of hours, days, months, quarters, or years in which the first set of data is received and the second set of data is determined.

In some embodiments, the predefined width constant (K) defines a width of a centered weighted moving average window technique that impacts the one or more KPI values of the one or more components.

In some embodiments, the at least one real travel distance (Sᵣ) and the at least one baseline travel distance (S_{b}) correspond to a sum of absolute values of changes in the plurality of positions of the one or more components of the HVAC system. In some embodiments, the change in the plurality of positions is the difference between two successive values in a time series.

In some embodiments, the one or more KPI values corresponds to lifespan loss and energy loss in percentage related to estimated lifespan and consumed energy during a nominal operation of the one or more components of the HVAC system in the predefined time period.

In some embodiments, the one or more components comprises at least one of a valve and an air damper of the HVAC system.

In another example embodiment, a system is disclosed. The system comprises a memory and at least one processor communicatively coupled to the memory. The at least one processor is configured to receive a first set of data associated with plurality of positions of one or more components of a Heating, Ventilation, and Air Conditioning (HVAC) system, from one or more sensors, in a predefined time period. Further, the at least one processor is configured to determine a second set of data associated with the plurality of positions of the one or more components of the HVAC system, based at least on a predefined width constant (K), over the predefined time period. Further, the at least one processor is configured to determine at least one real travel distance (Sᵣ) associated with the plurality of positions of the one or more components of the HVAC system in the predefined time period based at least on the first set of data. Further, the at least one processor is configured to determine at least one baseline travel distance (S_{b}) associated with the plurality of positions of the one or more components of the HVAC system in the predefined time period based at least on the second set of data. Thereafter, the at least one processor is configured to determine one or more Key Performance Indicator (KPI) values of the one or more components for the predefined time period based at least on the determined Sᵣ and S_{b}.

In some embodiments, the first set of data corresponds to a time series of historical data associated with the plurality of positions of the one or more components of the HVAC system. In some embodiments, the second set of data corresponds to a baseline time series data associated with the plurality of positions of the one or more components of the HVAC system.

In some embodiments, the one or more sensors comprises at least one of a limit switch sensor, potentiometers, encoders, hall effect sensors, proximity sensors, ultrasonic sensors, optical sensors, linear variable differential transformer (LVDT) sensors, and pressure sensors. In some embodiments, the predefined time period corresponds to a monitored time period comprising at least one of hours, days, months, quarters, or years in which the first set of data is received and the second set of data is determined.

In some embodiments, the predefined width constant (K) defines a width of a centered weighted moving average window technique that impacts the one or more KPI values of the one or more components.

In another example embodiment, a non-transitory machine-readable information storage medium is disclosed. The non-transitory machine-readable information storage medium comprising one or more instructions which when executed by at least one processor to perform operations comprising receiving a first set of data associated with plurality of positions of one or more components of a Heating, Ventilation, and Air Conditioning (HVAC) system, from one or more sensors, in a predefined time period; determining a second set of data associated with the plurality of positions of the one or more components of the HVAC system based at least on a predefined width constant (K), over the predefined time period; determining at least one real travel distance (Sᵣ) of the plurality of positions of the one or more components of the HVAC system in the predefined time period based at least on the first set of data; determining at least one baseline travel distance (S_{b}) of the plurality of positions of the one or more components of the HVAC system in the predefined time period based at least on the second set of data; and determining one or more Key Performance Indicator (KPI) values of the one or more components for the predefined time period based at least on the determined Sᵣ and S_{b}.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for determining losses (financial, energy, and lifetime losses) in a Heating, Ventilation, and Air Conditioning (HVAC) system in accordance with an example embodiment of the present disclosure;

FIG. 2 illustrates a block diagram of a server in accordance with an example embodiment of the present disclosure;

FIG. 3A illustrates a control loop of the system for determining losses of oscillating cooling in the HVAC system in accordance with an example embodiment of the present disclosure;

FIG. 3B illustrates a control loop of the system for determining losses of oscillating heating in the HVAC system in accordance with an example embodiment of the present disclosure;

FIG. 3C illustrates a control loop of the system for determining losses of oscillating ventilation in the HVAC system in accordance with an example embodiment of the present disclosure;

FIG. 4 illustrates a graphical representation of a plurality of positions of one or more components in a predefined time period in accordance with an example embodiment of the present disclosure;

FIG. 5 illustrates a graphical representation of the plurality of positions of the one or more components in another predefined time period in accordance with an example embodiment of the present disclosure;

FIG. 6A illustrates a graphical representation of fluctuation in zone temperature in accordance with an example embodiment of the present disclosure;

FIG. 6B illustrates another graphical representation of fluctuations in the plurality of positions based on the fluctuation of valve position causing the fluctuations of zone temperature in accordance with an example embodiment of the present disclosure;

FIG. 7A illustrates a graphical representation of a detailed time course of the plurality of positions and daily time courses of real and ideal travel distances in accordance with an example embodiment of the present disclosure;

FIG. 7B illustrates a graphical representation of estimated daily lifespan loss that corresponds to valve position changes in FIG. 7A in accordance with an example embodiment of the present disclosure; and

FIG. 8 illustrates a flowchart showing a method for determining losses in the HVAC system in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems to determine losses due to unwanted oscillations in a Heating, Ventilation, and Air Conditioning (HVAC) system. The losses may correspond to energy losses, lifetime losses, and financial losses. Embodiments may be configured to receive a first set of data associated with a plurality of positions of one or more components of the HVAC system, from one or more sensors, over a predefined time period. The first set of data corresponds to a time series of historical data associated with the plurality of positions of the one or more components of the HVAC system. The one or more sensors comprises at least one of limit switch sensors, potentiometers, encoders, hall effect sensors, proximity sensors, ultrasonic sensors, optical sensor, linear variable differential transformer (LVDT) sensors, and pressure sensors. The predefined time period corresponds to a monitored time period comprising at least one of hours, days, months, quarters, or years in which the first set of data is received and the second set of data is determined. The one or more components comprises at least one of a valve and an air damper of the HVAC system.

Embodiments may be configured to determine a second set of data associated with the plurality of positions of the one or more components of the HVAC system. The second set of data may be determined based at least on a predefined width constant (K), in the predefined time period. The second set of data corresponds to a baseline time series data associated with the plurality of positions of the one or more components of the HVAC system. The predefined width constant (K) defines a width of a centered weighted moving average window technique that impacts the one or more KPI values of the one or more components.

Embodiments may be configured to determine at least one real travel distance (Sᵣ) associated with the plurality of positions of the one or more components of the HVAC system in the predefined time period based at least on the first set of data. The at least one real travel distance (Sᵣ), and the at least one baseline travel distance (S_{b}) correspond to a sum of absolute values of changes in the plurality of positions of the one or more components of the HVAC system. Embodiments may be further configured to determine at least one baseline travel distance (S_{b}) associated with the plurality of positions of the one or more components of the HVAC system in the predefined time period based at least on the second set of data. Thereafter, embodiments may be configured to determine one or more Key Performance Indicator (KPI) values of the one or more components for the predefined time period based at least on the determined Sᵣ and S_{b}. The one or more KPI values corresponds to lifespan loss and energy loss in percentage related to estimated lifespan and consumed energy during a nominal operation of the one or more components of the HVAC system in the predefined time period.

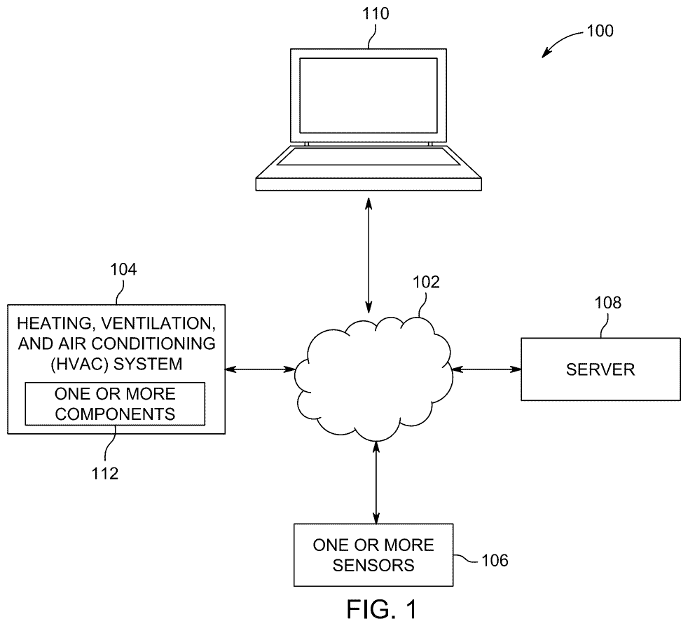

FIG. 1 illustrates a network diagram of a system 100 for determining losses (financial, energy, and lifetime losses) in a Heating, Ventilation, and Air Conditioning (HVAC) system 104, in accordance with an example embodiment of the present disclosure. The network diagram may comprise a network 102 communicatively coupled to the HVAC system 104, one or more sensors 106, a server 108, and a user device 110. Further, the HVAC system 104 may comprise one or more components 112.

In some embodiments, the network 102 may be a communication network such as Internet or a cloud network. The network 102 may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as Wide Area Networks (WANs) or Local Area Networks (LANs), while wireless devices may include wireless communications established via Radio Frequency (RF) signals or infrared signals. Various devices in the system 100 may connect to the network 102 in accordance with various wired and wireless communication protocols such as Transmission Control Protocol and Internet Protocol (TCP/IP), User Datagram Protocol (UDP), and 2G, 3G, or 4G communication protocols.

In some embodiments, the network 102 may be communicatively coupled to the HVAC system 104. In some embodiments, the HVAC system 104 may be installed within a building for regulating and maintaining internal temperatures. In some embodiments, the HVAC system 104 may be configured to provide heating by various means, such as furnaces, boilers, heat pumps, and electric heaters. The HVAC system 104 may be configured to generate heat to warm the indoor environment during colder weather conditions. Further, the HVAC system 104 may be configured to facilitate to exchange indoor air with outdoor air to improve air quality and remove contaminants such as odors, moisture, and pollutants. In some embodiments, the HVAC system 104 may also be configured to cool and dehumidify indoor air in order to maintain comfortable temperatures during hot weather. The HVAC system 104 may be configured to use air conditioners, chillers, evaporative coolers, and heat pumps to remove heat from indoor air. Further, HVAC system 104 may be configured to use air conditioners, chillers, evaporative coolers, and heat pumps to circulate cool air throughout the space.

In some embodiments, the HVAC system 104 may comprise the one or more components 112. Further, the one or more components 112 may comprise at least one of a valve and an air damper. The valve of the HVAC system 104 may regulate the flow of chilled water in cooling coil of Air Handling Units (AHUs) supplying cool air to different zones. In one example embodiment, the valve may correspond to a hot water (or steam) valve that may regulate the flow of hot water (or steam) in AHUs supplying heat/hot air to different zones. The air damper of the HVAC system 104 may control the flow of conditioned air within ductwork to different zones or areas of a building through the HVAC system 104 to regulate temperature. In some embodiments, the one or more components may correspond to any component, in which wear and consumed energy are proportional to the at least one real travel distance (Sᵣ) and the at least one baseline travel distance (S_{b}).

In some embodiments, the one or more components 112 may regulate the flow of air or fluid to maintain desired conditions within the building. In some embodiments, the one or more components 112 may be configured to move between one or more positions, example opening or closing, or opening 25% to opening to 27%. The system 100 may target the one or more components 112 with sufficiently fine resolution of positions such as 1% or so. In some embodiments, when minimum and maximum positions of the one or more components may be defined with fine resolution, the system 100 may be applicable. The change in a plurality of positions may be executed to regulate indoor temperature with respect to outdoor temperature. Further, the change in the one or more positions excessively may cause oscillations in the one or more components 112 of the HVAC system 104.

The one or more components 112 may oscillate when there may be issues with the control loop parameters or improper functioning of the HVAC system 104. The oscillations may lead to change in the plurality of positions of the one or more components 112. The change in the plurality of positions may result in inefficiencies in the HVAC system 104 operation. The change in the plurality of positions of the one or more components may result in energy loss, and lifespan loss due to wear and tear of the one or more components 112. Further, the server 108 may monitor the plurality of positions of the one or more components 112 using the one or more sensors 106 installed within the HVAC system 104.

In some embodiments, the one or more sensors 106 may comprise at least one of a limit switch sensor, potentiometers, encoders, hall effect sensors, proximity sensors, ultrasonic sensors, optical sensors, linear variable differential transformer (LVDT) sensors, and pressure sensors. The one or more sensors 106 may be configured to detect a first set of data associated with a plurality of positions of one or more components of the HVAC system 104. In some embodiments, the server 108 may receive data from the one or more sensors 106. Further, the received data may be processed to determine the Key Performance Indicator (KPI) values associated with the one or more components 112 operation. Further, the KPI values may quantify the percentage of lifespan loss and energy loss attributable to oscillations in the plurality of positions of the one or more components 112. In some embodiments, the one or more sensors 106 may detect the plurality of positions of the moving one or more components 112 within the HVAC system 104.

In one exemplary embodiment, the limit switch sensors may be configured to detect the first set of data by providing discrete feedback when a moving component from the one or more components 112 reaches a position from the plurality of position. In some embodiments, the first set of data corresponds to a time series of historical data associated with the plurality of positions of the one or more components of the HVAC system 104. For example, in the HVAC system 104, the limit switch sensor is installed to detect when a damper reaches fully open or fully closed positions. As the damper moves, the damper triggers the limit switch sensor, signaling the one or more sensors 106 about the current position of the damper. The single as a binary feedback from the limit switch sensor may indicate specific positions of the damper, forming the basis for the first set of data.

In another exemplary embodiment, the potentiometers may detect the first set of data by translating mechanical movement into electrical signals proportional to the plurality of positions of the one or more components 112. Within the HVAC system 104, a potentiometer may be integrated into a valve actuator to measure the degree of valve opening. As the valve actuator rotates, the potentiometer's resistance may change accordingly, providing continuous positional feedback as an analog signal. The analog signal generated by the potentiometer may offer precise information about the position of the valve, constituting the first set of data.

In another exemplary embodiment, the encoders may detect the first set of data by converting mechanical motion into digital signals representing position changes. For instance, in the HVAC system 104, an encoder may be attached to a motor driving a fan or a damper. As the motor rotates, the encoder generates digital pulses, each corresponding to a specific position change. By counting the generated digital pulses, the one or more sensors 106 may accurately track the position of the motor and, by extension, the connected component, forming the basis for the first set of data.

In another exemplary embodiment, the hall effect sensors may detect magnetic fields generated by moving the one or more components 112, enabling non-contact position sensing. In the HVAC system 104, the Hall effect sensors may be utilized to monitor the position of a magnet attached to a moving part, such as a damper or a valve. As the magnet moves past the Hall effect sensor, the magnet generates a voltage proportional to the magnetic field strength, indicating the position of the component. The generated the voltage output provides valuable information about the position of the component, constituting part of the first set of data.

In another exemplary embodiment, the proximity sensors may detect the presence or absence of the one or more components 112 within the detection range, by offering reliable position detection without physical contact. Within the HVAC system 104, the proximity sensors may be deployed to monitor the position of components such as dampers or valves. By detecting the presence of a target or an actuator attached to the moving part, proximity sensors may determine the position of the component without direct contact, thus contributing to the first set of data.

In another exemplary embodiment, the ultrasonic sensors may utilize sound waves to measure distances, by providing versatile and non-intrusive position sensing capabilities. In the HVAC system 104, ultrasonic sensors may be employed to monitor the position of the one or more components 112 such as dampers or valves. By emitting ultrasonic pulses and measuring the time it takes for them to bounce back from the moving part, ultrasonic sensors can determine the distance to the component, thereby indicating its position and contributing to the first set of data.

In another exemplary embodiment, the optical sensors may employ light detection principles to precisely detect the one or more components 112 positions, by offering high accuracy and reliability. Within the HVAC system 104, optical sensors could be utilized to monitor the position of components such as dampers or valves. By emitting light beams and detecting changes in light intensity caused by the movement of the component, optical sensors can determine its position accurately, forming an essential part of the first set of data.

In another exemplary embodiment, the LVDT sensors may precisely detect the plurality of positions of the one or more components that are moving within the HVAC system 104. The LVDT sensors may monitor the opening and closing of air dampers or valves crucial for regulating airflow or temperature of air. As the system 100 operates, the LVDT sensors may continuously measure the plurality of positions of the one or more components that are moving, by capturing data on the exact locations throughout the operational range of the LVDT sensors. The data, combined with information from other one or more sensors, may forms the first set of data.

In another exemplary embodiment, the pressure sensors may measure changes in pressure within the HVAC system 104 by providing indirect but valuable insights into the movement and operation of the one or more components 112. For example, in the HVAC system 104, the pressure sensors may be installed to monitor the pressure differential across a damper or a valve. As the damper or the valve moves, the damper or the valve affects the airflow and subsequently the pressure, that can be detected by the pressure sensors. By analyzing the pressure changes, the one or more sensors 106 may infer the position of the component, contributing to the first set of data.

In some embodiments, the server 108 may be a computer or software module that is configured to provide centralized resources, data, or services to the user device 110 operated by a user. The server 108 may be configured to handle and manage one or more computational tasks and data processing within the system 100. In some embodiments, the server 108 may include storage systems, such as hard drives or storage arrays, to store and manage large volumes of data and information accessible to network users. In some embodiments, the server 108 may further provide centralized control and management capabilities, allowing network administrators to configure, monitor, and maintain network resources, security settings, and user access permissions from a single location.

In some embodiments, the server 108 may be configured to receive the first set of data associated with the plurality of positions of the one or more components of the HVAC system 104, from the one or more sensors 106, over a predefined time period. The first set of data may correspond to a time series of historical data associated with the plurality of positions of the one or more components of the HVAC system 104. In some embodiments, the server 108 may be configured to determine a second set of data associated with the plurality of positions of the one or more components of the HVAC system 104, based at least on a predefined width constant (K), in the predefined time period. The second set of data may correspond to a baseline time series data associated with the plurality of positions of the one or more components of the HVAC system 104. Further, the K may define a width of a centered weighted moving average window technique that impacts the one or more KPI values of the one or more components. In some embodiments, the one or more components may comprise at least one of a valve and an air damper.

In some embodiments, the server 108 may be configured to determine at least one real travel distance (Sᵣ) associated with the plurality of positions of the one or more components of the HVAC system 104 in the predefined time period based at least on the first set of data. The predefined time period may correspond to a monitored time period comprising at least one of hours, days, months, quarters, or years in which the first set of data is received and the second set of data is determined. In some embodiments, the server 108 may be configured to determine at least one baseline travel distance (S_{b}) associated with the plurality of positions of the one or more components of the HVAC system 104 in the predefined time period based at least on the second set of data. In one example embodiment, the at least one real travel distance (Sᵣ), and the at least one baseline travel distance (S_{b}) may correspond to a sum of absolute values of changes in the plurality of positions of the one or more components of the HVAC system 104.

In some embodiments, the server 108 may be configured to determine one or more Key Performance Indicator (KPI) values of the one or more components for the predefined time period based at least on the determined Sᵣ and S_{b}. The one or more KPI values may correspond to lifespan loss and energy loss in percentage related to estimated lifespan and consumed energy during a nominal operation of the one or more components of the HVAC system 104 in the predefined time period.

In some embodiments, the server 108 may be a computer or software module that is configured to provide centralized resources, data, or services to the user device 110 operated by a user. The server 108 may be configured to handle and manage one or more computational tasks and data processing within the system 100. In some embodiments, the server 108 may include storage systems, such as hard drives or storage arrays, to store and manage large volumes of data and information accessible to network users. In some embodiments, the server 108 may further provide centralized control and management capabilities, allowing network administrators to configure, monitor, and maintain network resources, security settings, and user access permissions from a single location.

In some embodiments, the server 108 may further be configured to send the determined one or more KPI values along with the first set of data and the second set of data to the user device 110. The user device 110 may be equipped by a manager of the HVAC system 104 or other service professionals responsible for addressing the oscillations in the HVAC system 104. In some embodiments, the determined one or more KPI values by the server 108 may provide a summarized data to the user that is easy to understand and take action. The user device 110 may serve as an interface through which a user may monitor the performance of the HVAC system 104, and may view the KPI values. In some embodiments, the user device 110 may include personal computers such as desktop computers, laptop computers, tablets, smartphones, or mobile devices.

In some embodiments, the server 108 may be configured to generate the summarized data in the form of tables, graphs, animations, numerical values etc. In some embodiments, the summarized data may be configured to provide an economic assessment to determine impact of the oscillations in the HVAC system 104. In some embodiments, the summarized data may include assessment of energy consumption of the one or more components 112 in the HVAC system 104. Further, the summarized data may include lifespan reduction of each of the one or more components 112 in the HVAC system 104. Further, the summarized data may include estimated maintenance cost or additional costs corresponding to the one or more components 112 of the HVAC system 104.

It will be apparent to one skilled in the art that above-mentioned components of the system 100 have been provided only for illustration purposes, without departing from the scope of the disclosure.

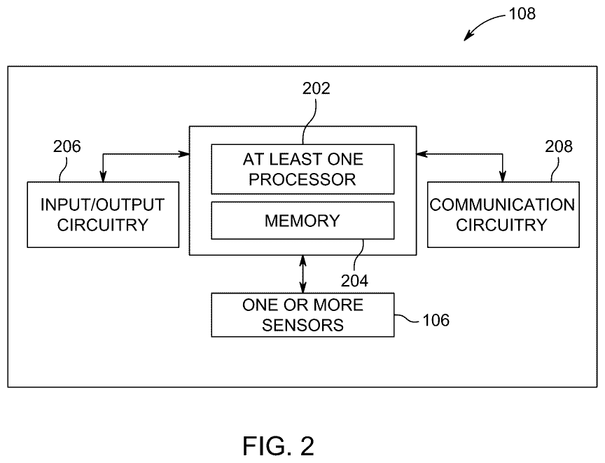

FIG. 2 illustrates a block diagram of the server 108 in accordance with an example embodiment of the present disclosure. FIG. 2 is described in conjunction with FIG. 1. In some embodiments, the server 108 may comprise at least one processor 202, a memory 204, an input/output circuitry 206, and a communication circuitry 208.

In some embodiments, the at least one processor 202 may be configured to receive the first set of data associated with the plurality of positions of the one or more components 112 of the HVAC system 104, from the one or more sensors 106, over the predefined time period. The first set of data may correspond to a time series of historical data associated with the plurality of positions of the one or more components 112 of the HVAC system 104. Further, the one or more components 112 may comprise at least one of a valve and an air damper of the HVAC system 104. In one example, the at least one processor 202 receives a first set of data of historical positions of valves of a complex HVAC system 104 regulating the flow of chilled water in cooling coil of Air Handling Units supplying cool air to different zones, from the one or more sensors 106 such as limit switch sensors or potentiometers. In yet another example, the at least one processor 202 receives a first set of data of historical positions of air dampers of a complex HVAC system 104 that controls the flow of conditioned air within ductwork to different zones or areas of a building through the HVAC system 104 to regulate temperature, from the one or more sensors 106 such as proximity sensors or ultrasonic sensors.

As discussed above in FIG. 1, the one or more sensors 106 may comprise at least one of the limit switch sensor, potentiometers, encoders, hall effect sensors, proximity sensors, ultrasonic sensors, optical sensors, LVDT sensors, and pressure sensors. In some embodiments, the at least one processor 202 may receive data from the one or more sensors 106. Further, the received data may be processed to determine the one or more KPI values associated with the one or more components 112 operation. Further, the one or more KPI values may quantify the percentage of lifespan loss and energy loss attributable to oscillations in the plurality of positions of the one or more components 112. In some embodiments, the one or more sensors 106 may detect the plurality of positions of the moving one or more components 112 within the system 100. In some embodiments, the plurality of positions of the one or more components 112 may be changing during the operation of the system 100. In one example, the ultrasonic sensor is configured to monitor the valve of the HVAC system 104 that may open to 15%, next moment to 20%, then to 28%. The plurality of positions of the one or more components 112 may be monitored to check for oscillations in the HVAC system 104.

In some embodiments, the at least one processor 202 may be configured to determine the second set of data associated with the plurality of positions of the one or more components 112 of the HVAC system 104, based at least on the K, in the predefined time period. In some embodiments, the second set of data may correspond to the baseline time series data associated with the plurality of positions of the one or more components 112 of the HVAC system 104. In some embodiments, the predefined time period may correspond to the monitored time period comprising at least one of hours, days, months, quarters, or years in which the first set of data is received and the second set of data is determined. In some embodiments, proper selection of the predefined width constant (K) may help to filter out oscillations in the second set of data. Further, proper selection of the predefined width constant (K) may not prevent the second set of data from maintaining a regulated value of the plurality of positions of the one or more components 112, at a level desired by a user.

In one example, the at least one processor 202 applies a predefined width constant (K) to determine a baseline time series data of the valves' positions forming the second set of data. The baseline time series data helps to establish what the expected positions of the valves should be under normal operation. In another example, the at least one processor 202 applies a predefined width constant (K) to determine a baseline time series data of the air dampers' positions forming the second set of data. The baseline time series data helps to establish what the expected positions of the air dampers should be under normal operation.

In one example, the at least one processor 202 is configured to determine the second set of data as the baseline time series for the valve of the HVAC system 104. The at least one processor is configured to determine the baseline time series for the same 30-day time period as in the above example. The at least one processor may be configured to determine the second set of data using the predefined width constant (K). In some embodiments, the second set of data is determined by using the frequent oscillations due to the variations in the one or more positions of the valve.

In some embodiments, the at least one processor 202 may be configured to determine at least one real travel distance Sᵣ associated with the plurality of positions of the one or more components 112 of the HVAC system 104 in the predefined time period based at least on the first set of data. Sᵣ may correspond to a sum of absolute values of changes of the plurality of real positions. In some embodiments, the at least one real travel distance Sᵣ may be calculated using a formula-(1).

$${S}_{r} = {\sum }_{j = 1}^{N} abs ( {p}_{j} - {p}_{j - 1} ) \qquad ( 1 )$$

In some embodiments, the pⱼ corresponds to a series of plurality of positions of the one or more components 112, for Sᵣ. For the HVAC operation, a frequency of sampling may be considered. Further, a suitable time sampling interval may be used. It may be noted that the time sampling interval must be appropriately fine, not too coarse. The time sampling interval may depend on the frequency of oscillations. In one example embodiment, the frequency of operation may be one sample per minute. In one example, the at least one processor 202 determines the Sᵣ based on the first set of data of the valves. In yet another example, the at least one processor 202 determines the Sᵣ based on the first set of data of the air dampers.

Further, the at least one processor 202 may be configured to determine at least one baseline travel distance S_{b} is associated with the plurality of positions of the one or more components 112 of the HVAC system 104 in the predefined time period based at least on the second set of data. The S_{b} may correspond to a sum of absolute values of changes of the plurality of positions in baseline.

Further, the at least one real travel distance Sᵣ, and the at least one baseline travel distance S_{b} may correspond to a sum of absolute values of changes in the plurality of positions of the one or more components 112 of the HVAC system 104. In some embodiments, the at least one position series baseline may be constructed by applying commonly known centered weighted moving average method with a window 2K samples wide on the series of plurality of positions pⱼ, using a formula-(2)

$${p}_{b , i} = \frac{1}{2 \cdot K + 1} \cdot {\sum }_{j = - K}^{K} {w}_{j} \cdot {p}_{( i - j )} , i = k , … N - K \qquad ( 2 )$$

where wⱼ, j=−K, −K+1, . . . , K−1, K is a sequence of suitable weights for individual window elements. Further, the weights wⱼ are normalized so that their sum is equal to one:

$${\sum }_{j = - K}^{K} {w}_{j} = 1$$

The at least one baseline travel distance S_{b} is calculated from the baseline time series of positions p_{b,i} using formula (3)

$${S}_{b} = {\sum }_{i = 1}^{N} abs ( {p}_{b , i} - {p}_{b , i - 1} ) \qquad ( 3 )$$

where p_{b,i} is the time series of baseline oscillating valve positions. The second index, i or (i−j) here, may represents time, N is the length of the monitoring series.

In one example, the at least one processor 202 determines the S_{b} based on the second set of data of the valves. The Sᵣ and the S_{b} represents the sum of changes in valve positions over the predefined time period. The sum of changes may be calculated as the sum of the absolute values of the differences between subsequent positions from the plurality of positions. In another example, the at least one processor 202 determines the S_{b} based on the second set of data of the air dampers. The Sᵣ and the S_{b} represents the sum of changes in air dampers positions over the predefined time period.

In some embodiments, the at least one processor 202 may be configured to determine one or more KPI values of the one or more components 112 for the predefined time period based at least on the determined Sᵣ and S_{b}. The one or more KPI values corresponds to lifespan loss and energy loss in percentage related to estimated lifespan and consumed energy during a nominal operation of the one or more components 112 of the HVAC system 104 in the predefined time period. In some embodiments, the K may define a width of a centered weighted moving average window technique that impacts the one or more KPI values of the one or more components 112. In some embodiments, the one or more KPI values may be calculated by using formula-(4).

$${KPI}_{T} = ( 1 - \frac{{S}_{b}}{{S}_{r}} ) \cdot 100 \% \qquad ( 4 )$$

In one example embodiment, the value S_{b} is always >0, because of non-constant baseline curve. Sᵣ≥S_{b} and therefore 0%≤KPI_{T}<100%. In another example embodiment, for Sᵣ=0, and S_{b}=0, KPI_{T} equal to 0.

In one example, the at least one processor 202 determines one or more KPI values for each valve, using the Sᵣ and the S_{b}. The one or more KPI values indicate the percentage of lifespan and energy wasted due to oscillations in the valves. If a valve's KPI value is 85% after a month of oscillations, it means approximately a part of the lifetime-85% of one-month long lifespan is lost, and 85% of the one-month long energy consumed by the valve is wasted.

In yet another example, the at least one processor 202 determines one or more KPI values for each air damper, using the Sᵣ and the S_{b}. The one or more KPI values indicate the percentage of lifespan and energy wasted due to oscillations in the air damper. If an air damper's KPI value is 89% after a month of oscillations, it means approximately a part of the lifetime—89% of one-month long lifespan is lost, and 89% of the one-month long energy consumed by the damper is wasted.

In some embodiments, a wider centered weighted moving average window may filter out lower frequencies, resulting in a smoother baseline. For example, consider outdoor temperature fluctuations throughout the day that rises in the morning, peaks around 14:00, and then decreases. Cooling systems must adapt to the fluctuations to maintain indoor temperature stability, adjusting cooling output accordingly. However, an excessively wide centered weighted moving average window may lead to decrease the accuracy of the baseline estimate. The excessively wide windows in control algorithms result in flattened cooling valve positions, potentially leading to poor temperature regulation and maintenance. Filtering out too low frequencies by the wide centered weighted moving average window may result in wrong estimate of the baseline.

The at least one processor 202 may include suitable logic, circuitry, and/or interfaces that are operable to execute one or more instructions stored in the memory 204 to perform predetermined operations. In some embodiments, the at least one processor 202 may be communicatively coupled to the memory 204. In one embodiment, the at least one processor 202 may be configured to decode and execute any instructions received from one or more other electronic devices or server(s). The at least one processor 202 may be configured to execute one or more computer-readable program instructions, such as program instructions to carry out any of the functions described in this description. Further, the processor may be implemented using one or more processor technologies known in the art. Examples of the at least one processor 202 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 204 may be configured to store a set of instructions and data executed by the at least one processor 202. Further, the memory 204 may include the one or more instructions that are executable by the at least one processor 202 to perform specific operations. The memory 204 may be configured to include the instructions to receive the first set of data associated with the plurality of positions of the one or more components 112 of the HVAC system 104, from the one or more sensors 106, in the predefined time period. The memory 204 may be configured to include the instructions to determine the second set of data associated with the plurality of positions of the one or more components 112 of the HVAC system 104. Further, the memory 204 may be configured to include the instructions to determine the Sᵣ associated with the plurality of positions of the one or more components 112 of the HVAC system 104. Further, the memory 204 may be configured to include the instructions to determine the S_{b} associated with the plurality of positions of the one or more components 112 of the HVAC system 104.

Thereafter, the memory 204 may be configured to include the instructions to determine the one or more KPI values of the one or more components 112. Furthermore, the memory 204 may be configured to include the instructions to determine the financial losses due to unwanted oscillations in the HVAC system 104. It is apparent to a person with ordinary skill in the art that the one or more instructions stored in the memory 204 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 108 may further comprise the input/output circuitry 206. The input/output circuitry 206 may enable a user to communicate or interface with the system 100, via the user devices (not shown). The one or more user devices may include N number of user devices 110. In some embodiments, the input/output circuitry 206 may act as a medium to transmit input from the interface to and from the system 100. In some embodiments, the input/output circuitry 206 may refer to the hardware and software components that facilitate the exchange of information between one or more user devices and the system 100. In one example, the server 108 may include a graphical user interface (GUI) (not shown) as input circuitry to allow the users to input data. The input/output circuitry 206 may include various input devices such as keyboards, barcode scanners, GUI for the one or more users to provide data and various output devices such as displays, printers for the one or more users to receive data. In another example, the input/output circuitry 206 may include various output circuitry such as a display.

In some embodiments, the server 108 may further comprise the communication circuitry 208. The communication circuitry 208 may allow the system 100 to exchange data or information with other systems or apparatuses. Further, the communication circuitry 208 may include network interfaces, protocols, and software modules responsible for sending and receiving data or information. In some embodiments, the communication circuitry 208 may include Ethernet ports, Wi-Fi adapters, or communication protocols like HTTP or MQTT for connecting with other systems. The communication circuitry 208 may further include components such as communication modules (e.g., Wi-Fi, Ethernet, cellular), transceivers, antennas, and protocols (e.g., TCP/IP, MQTT, SNMP) for exchanging data with other systems or network devices. The communication circuitry 208 may allow the system 100 to stay up-to-date and accurately track the one or more KPI values.

It will be apparent to one skilled in the art the above-mentioned components of the server 108 have been provided only for illustration purposes, without departing from the scope of the disclosure.

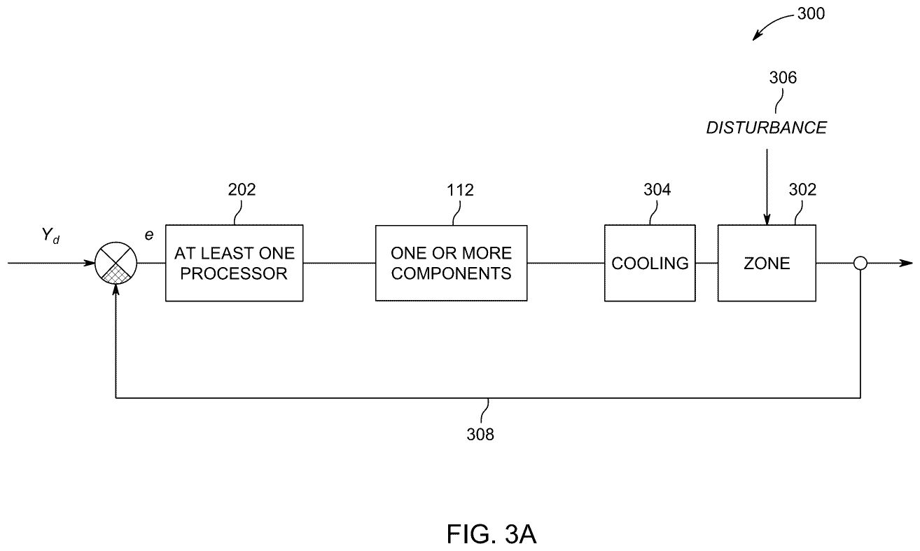

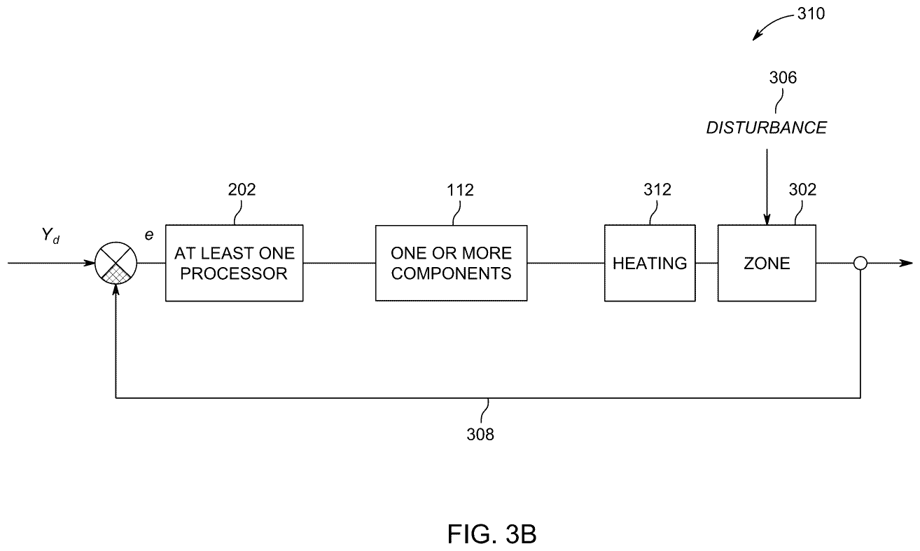

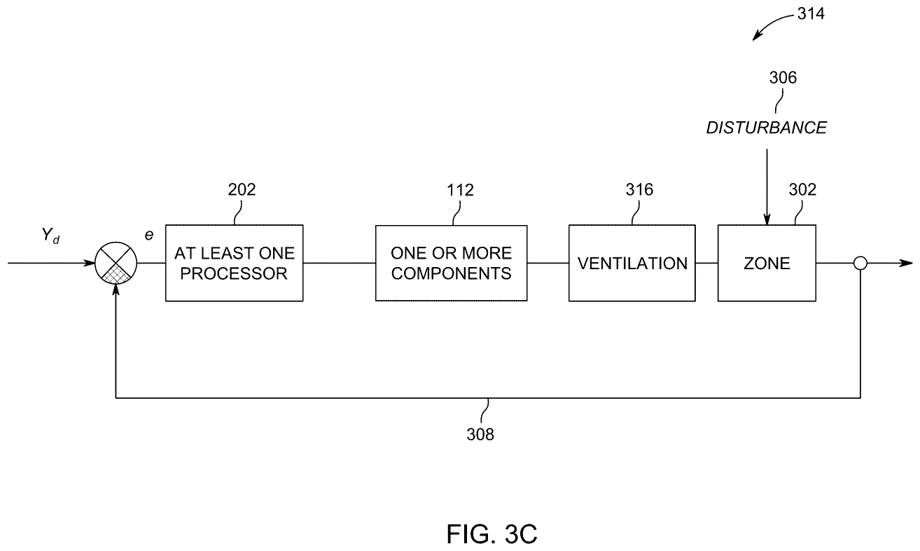

FIG. 3A illustrates a control loop 300 of the system 100 for determining losses of oscillating cooling in the HVAC system 104 in accordance with an example embodiment of the present disclosure. FIG. 3B illustrates a control loop 310 of the system 100 for determining losses of oscillating heating in the HVAC system 104 in accordance with an example embodiment of the present disclosure. FIG. 3C illustrates a control loop 314 of the system 100 for determining losses of oscillating ventilation in the HVAC system 104 in accordance with an example embodiment of the present disclosure. FIGS. 3A-3C are described in conjunction with FIGS. 1-2.

The control loop 300 may comprise the at least one processor 202, the one or more components 112, and a zone 302. In some embodiments, the system 100 may receive at least one input request from a user in the control loop 300. The at least one input request may be denoted by “Ya”. Further, the received at least one input request may be processed by the at least one processor 202. The at least one processor 202 may determine the plurality of positions of the one or more components 112 based at least on the processed at least one input request. Furthermore, the at least one processor 202 may send a command to correctly position the one or more components 112 based at least on the determined plurality of positions of the one or more components 112. The one or more components 112 may comprise at least one of the valve and the air damper. Further, the at least one processor 202 may control temperature of the zone 302. In one example, the at least one processor 202 may send a command to correctly position the one or more components 112 in order to provide cooling 304 to the zone 302, as illustrated in FIG. 3A. In another example, the at least one processor 202 may send a command to correctly position the one or more components 112 in order to provide heating 312 to the zone 302, as illustrated in FIG. 3B. In yet another example, the at least one processor 202 may send a command to correctly position the one or more components 112 in order to provide ventilation 316 to the zone 302, as illustrated in FIG. 3C. Further, the controlled temperature or ventilation of the zone 302 may be given as an output.

In some embodiments, the zone 302 may be introduced with disturbance 306. In the operation of the control loop 300, the disturbance 306 may manifest in one or more forms that may include any changes in external environmental conditions such as ambient temperature fluctuations, unexpected variations in airflow due to door openings or even fluctuations in occupancy levels within the zone 302.

Further, the control loop 300 may comprise a feedback loop 308. The feedback loop 308 may move from the output to the received at least one input request. The feedback loop 308 may help in minimizing the disturbance 306. Further, the controlled temperature of the zone 302 given as the output may include an error denoted by “e” due to one or more disturbances. The feedback loop 308 may minimize the error “e” in the output. In some embodiments, the oscillations in the one or more components 112 of the HVAC system 104 may emerge due to improper parameters of at least one processor 202. Further, the plurality of positions of the one or more components 112 may be provided in a range 0%-100%. The 0% may correspond to a lower limit of the plurality of positions. The 100% may correspond to an upper limit of the plurality of positions.

In one example, the control loop 300 may be installed within the HVAC 104 of a shopping complex. The control loop 300 of the HVAC system 104 of the shopping complex comprises the at least one processor 202. Further, the at least one processor 202 may be communicatively coupled to a valve installed with the HVAC system 104 of the shopping mall. Further, the valve of the HVAC system 104 may be operated to provide cooling within the mall. In the example, the system 100 receives at least one request from a manager of the shopping mall in the control loop 300. The at least one request from the manager is to change temperature settings within the shopping mall from 25 degrees to 19 degrees. Further, the received at least one input request may be processed by the at least one processor 202. The at least one processor 202 may determine the plurality of positions of the one or more components 112 based at least on the processed at least one input request. Furthermore, the at least one processor 202 may send a command to correctly position the one or more components 112 based at least on the determined plurality of positions of the one or more components 112.

Further, in the example, the at least one processor 202 is configured to generate a command for the valve installed with the HVAC 104 to open from 50% to 80%. In some embodiments, the change in position of the valve thereby changes the temperature inside the shopping mall. Further, in the example, the controlled temperature of the zone 302 (i.e., the shopping mall) may be given as an output. Further, during night, outside temperature of the shopping mall drops down significantly. Further, as discussed earlier, the control loop 300 may comprise the feedback loop 308. The feedback loop 308 may move from the output to the received at least one input request. The feedback loop 308 may help in minimizing the disturbance 306. Further, the controlled temperature of the zone 302 given as the output may include an error denoted by “e” due to one or more disturbances. In the example, the error may be cause due drop in temperature.

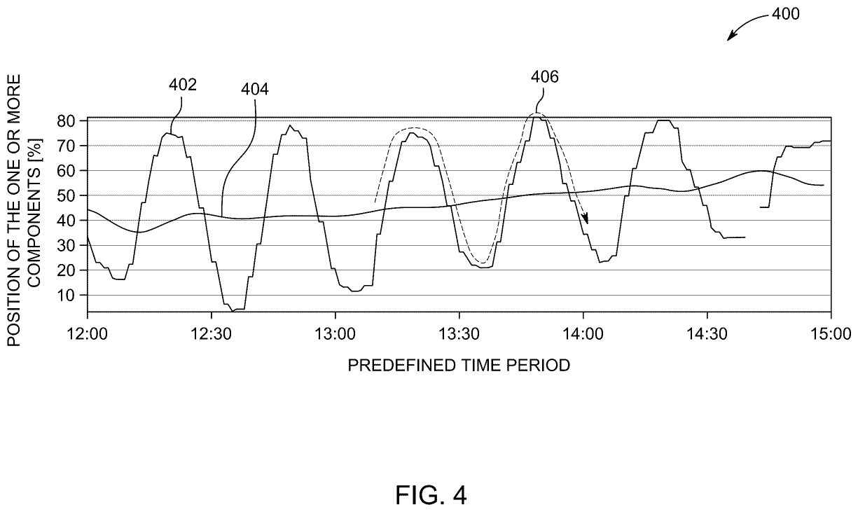

FIG. 4 illustrates a graphical representation 400 of the plurality of positions of the one or more components 112 in the predefined time period in accordance with an example embodiment of the present disclosure. FIG. 4 is described in conjunction with FIGS. 1-3.

As illustrated in FIG. 4, the graphical representation 400 may represent the plurality of positions of one or more components 112 in the predefined time period. The x-axis of the graphical representation 400 may represent the predefined time period in hours. The y-axis of the graphical representation 400 may represent the plurality of positions of the one or more components 112, in percentage. The graphical representation 400 may comprise at least one real travel distance (Sᵣ) 402 of a real position of the one or more components 112. Further, the graphical representation 400 may comprise at least one baseline travel distance (S_{b}) 404 of an ideal position of the one or more components 112. The graphical representation 400 may comprise a curve 406 representing a measurement of at least one real travel distance (Sᵣ), when the one or more components 112 oscillates between an upper limit and a lower limit of the plurality of positions.

In one example, the graphical representation 400 may represent the plurality of one or more positions of the valve of the HVAC system 104. The one or more positions of the valve is monitored between a time period of 12:00 till 15:00. Further, between the time period of 12:00 till 15:00 the zone served by HVAC system 104 is occupied. Further, starting from 12:00-12:30 time duration, the valve is opened from 30% to around 15%. Further, the valve gets opened from 15% up to 75% by 12:15. Further, after 12:15, the valve closes from 75% to 0% at around 12:30. In this example, the cycle of opening and closing of the valve continues between 0% up to 80%. Similarly, from the 13:00-13:30 time duration, the valve is opened from 10% to around 75% by 13:15. Further, after 13:15, the valve closes from 75% to 20% at around 13:30. Similarly, from the 14:00-14:30 time duration, the valve is opened from 20% to around 80% by 14:15. Further, after 14:15, the valve closes from 80% to 33% at around 14:30.

In this example, the at least one processor 202 is configured to determine the base travel distance S_{b}. As described earlier, the at least one baseline travel distance S_{b} is associated with the plurality of positions of the valve of the HVAC system 104 in the predefined time period based at least on the second set of data. Further, the at least one real travel distance Sᵣ, and the at least one baseline travel distance S_{b} may correspond to a sum of absolute values of changes in the plurality of positions of the valves of the HVAC system 104. The Sᵣ may correspond to the sum of absolute values of of changes the plurality of real positions. Further, the S_{b} may correspond to a sum of absolute values of changes of the plurality of positions in baseline. In some embodiments, the at least one baseline may be constructed by applying commonly known centered weighted moving average method with a window 2K samples wide onto changes in the plurality of positions of the valves of the HVAC system 104. In this example, the baseline or an ideal curve may be generated between time period of 12:00 till 15:00. The baseline or the ideal curve may be generated by removing the oscillation due to the one or more positions of the valve. The ideal curve at 12:00 may start from 45% and vary around 35% to 60% across the time period when the occupancy within the zone is identified.

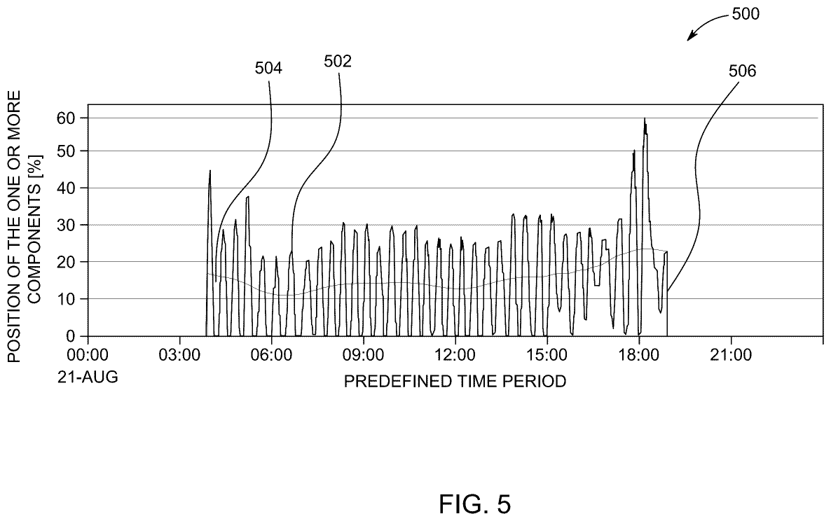

FIG. 5 illustrates a graphical representation 500 of the plurality of positions of the one or more components 112 in another predefined time period in accordance with an example embodiment of the present disclosure. FIG. 5 is described in conjunction with FIGS. 1-3.

As illustrated in FIG. 5, the graphical representation 500 may represent the plurality of positions of one or more components 112 in the predefined time period. The x-axis of the graphical representation 500 may represent the predefined time period in hours. The y-axis of the graphical representation 500 may represent the plurality of positions of the one or more components 112, in percentage. The graphical representation 500 may comprise at least one real travel distance (Sᵣ) 502 of a real position of the one or more components 112. Further, the graphical representation 500 may comprise at least one baseline travel distance (S_{b}) 504 of an ideal position of the one or more components 112. The graphical representation 500 may help in indicating the at least one baseline travel distance (S_{b}) 504, when the one or more components 112 oscillates between the plurality of positions.

In one example, the graphical representation 500 may represent the plurality of one or more positions of the valve of the HVAC system 104. The one or more positions of the valve is monitored between for 21^{st} August to 22^{nd} August. Further, between 21^{st} August to 22^{nd} August the zone where the HVAC system 104 is occupied from 04:00 to 19:00 as shown by line 506 as illustrated in FIG. 5. Further, starting from the 04:00-19:00 time duration, the valve is opened from 0% to around 60%. In this example, the at least one processor 202 is configured to determine the base travel distance S_{b}.

As described earlier in previous example, the at least one baseline travel distance S_{b} is associated with the plurality of positions of the valve of the HVAC system 104 in the predefined time period based at least on the second set of data. Further, the at least one real travel distance Sᵣ, and the at least one baseline travel distance S_{b} may correspond to a sum of absolute values of changes in the plurality of positions of the valves of the HVAC system 104. The Sᵣ may correspond to the sum of absolute values of changes of the plurality of real positions. Further, the S_{b} may correspond to a sum of absolute values of changes of the plurality of positions in baseline. The profile may be obtained by applying commonly known centered weighted moving average method with a window 2K samples wide. In this example, the baseline or an ideal curve may be generated between time period of 04:00 to 19:00 as illustrated in FIG. 5. The baseline or the ideal curve may be generated by removing the oscillation due to the one or more positions of the valve. The ideal curve at 04:00 may start from 15% and vary between 10% to 24% across the time period when the occupancy within the zone is identified.

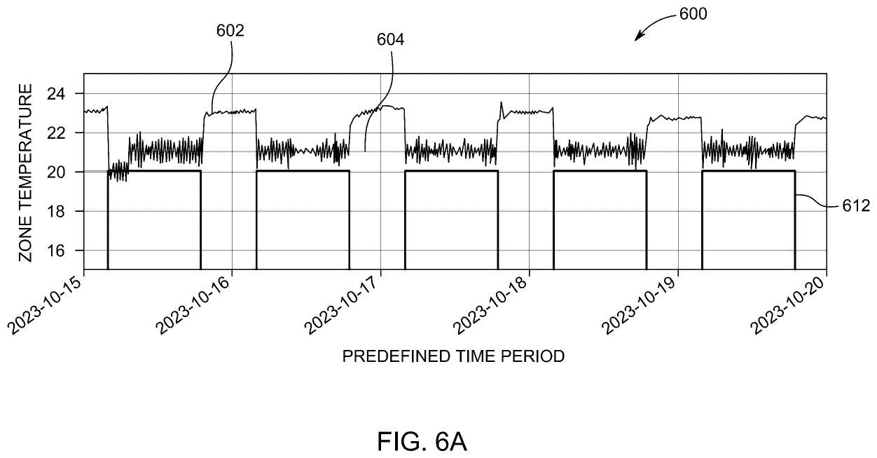

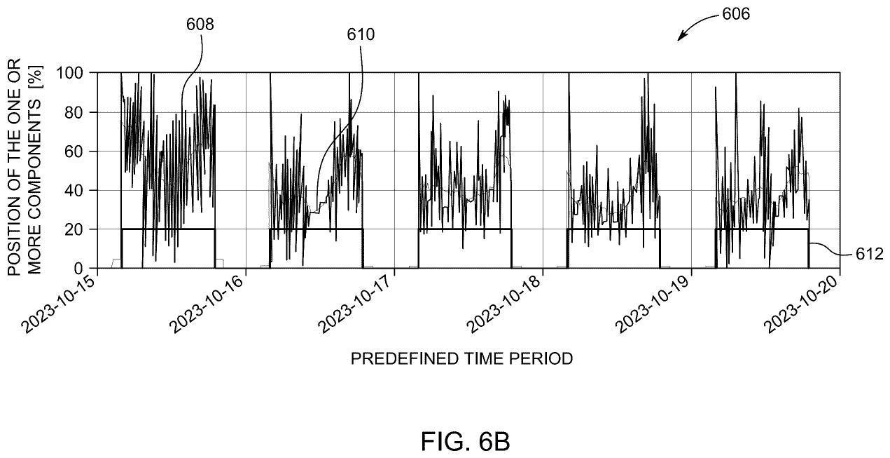

FIG. 6A illustrates a graphical representation 600 of fluctuation in zone temperature in accordance with an example embodiment of the present disclosure. FIG. 6A is described in conjunction with FIGS. 1-3.

As illustrated in FIG. 6A, the graphical representation 600 may represent fluctuation in zone temperature in the predefined time period. The x-axis of the graphical representation 600 may represent the predefined time period in days. The y-axis of the graphical representation 600 may represent the zone temperature caused due to the change in the plurality of positions of the one or more components 112. The graphical representation 600 may comprise at least one real temperature 602 associated with the real position of the one or more components 112. Further, the graphical representation 600 may comprise at least one ideal temperature 604 associated with the ideal position of the one or more components 112. In one example, the graphical representation 600 may represent fluctuations of the zone temperature during working hours of the predefined time interval.

In one example, the graphical representation 600 may represent the fluctuations in the zone temperature. The fluctuations in the zone temperature is monitored between 15 Oct. 2023 to 20 Oct. 2023. In this example, the occupancy within the zone is fluctuated which is shown by a line 612. Initially, when there is no occupancy in the zone, the zone temperature starts from 23 degrees and drops down to around 20 degrees when there is occupancy identified within the zone, and the air conditioning has started. Further, during the occupancy, the zone temperature ranges around 20-22 degrees. Similarly, when there is no occupancy detected, the zone temperature rises to around 23 degrees, as the HVAC system 104 is off. Similarly, in this example, the fluctuations in the zone temperature varies with the change in the occupancy in the zone.

FIG. 6B illustrates a graphical representation 606 of fluctuations in the plurality of positions based on the fluctuation of valve position causing the fluctuations of zone temperature, in accordance with an example embodiment of the present disclosure. FIG. 6B is described in conjunction with FIGS. 1-3 and FIG. 6A.

As illustrated in FIG. 6B, the graphical representation 606 may represent fluctuations in the plurality of positions based on the fluctuation of valve position causing the fluctuations of zone temperature in the predefined time period. The x-axis of the graphical representation 606 may represent the predefined time period in days. The y-axis of the graphical representation 606 may represent the plurality of positions of the one or more components 112, in percentage, that causes fluctuations in the zone temperature. The graphical representation 606 may comprise at least one real travel distance (Sᵣ) 608 of the real position of the one or more components 112 that causes fluctuations of zone temperature. Further, the graphical representation 606 may comprise at least one baseline travel distance (S_{b}) 610 of the ideal position of the one or more components 112 that causes fluctuations of zone temperature.

Further, the at least one baseline travel distance (S_{b}) 610 may represent the course of smooth stable positions of the one or more components 112. The at least one baseline travel distance (S_{b}) 610 may be expected to eliminate disturbances and maintain stable zone temperature without changes in the plurality of positions of the one or more components 112. In one example, air conditioning is switched off in the HVAC system 104 during night to setback cooling, having the one or more components 112 position at 0%. As a result, no wear and tear of the one or more components 112 is caused.

In one example, the graphical representation 600 may represent the plurality of one or more positions of the valve of the HVAC system 104 due to the various in the zone temperatures as discussed in the FIG. 6A. The one or more positions of the valve is monitored between 15 Oct. 2023 to 20 Oct. 2023 as discussed in the previous example. In this graphical representation 606, the plurality of one or more positions of the valve fluctuates when the occupancy within the zone is identified as shown by the line 612. In this example, starting from 15 Oct. 2023, the valve is opened from 0% to 100%, when the occupancy is determined. The one or more positions of the valve depends on the fluctuations in the zone temperature as described earlier in FIG. 6A. In this example, when the occupancy is not identified between the days, the HVAC system 104 is switched off at night. Here, the valve is at 0% opening. During this period, the valve does not involve any wear and tear.

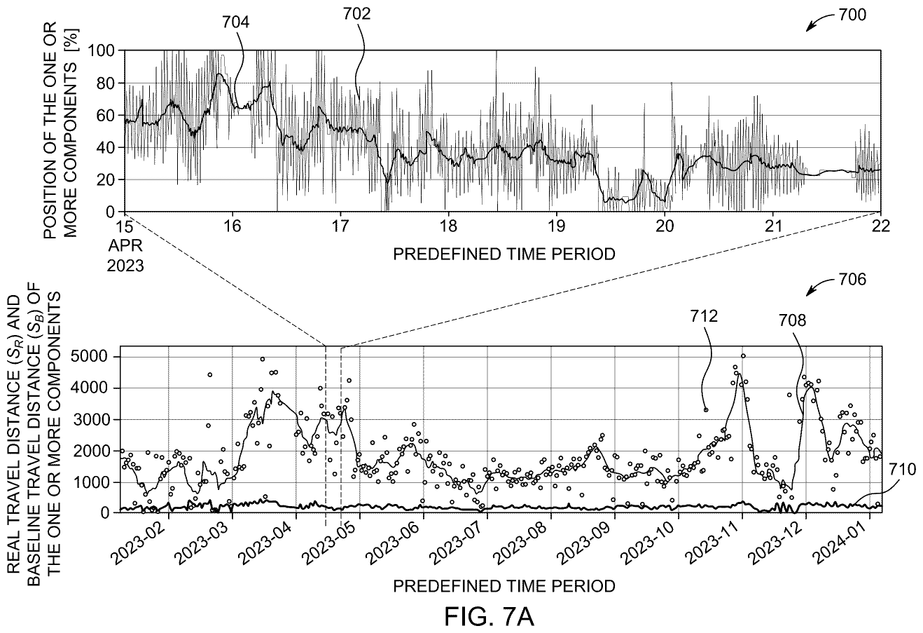

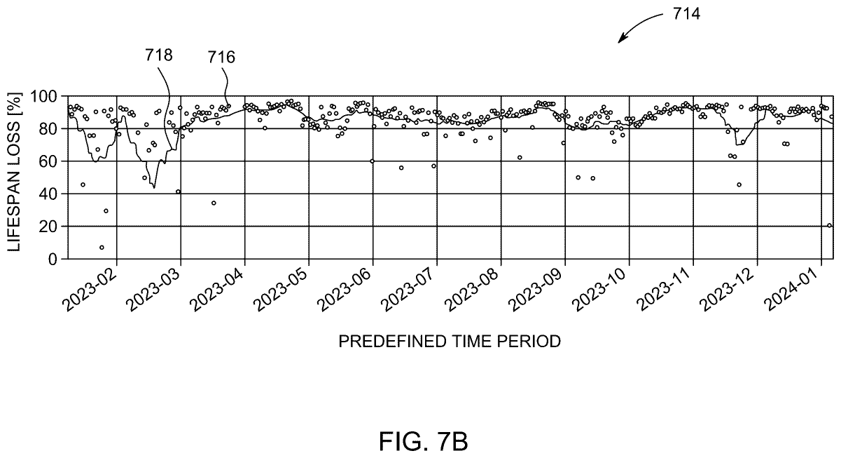

FIG. 7A illustrates a graphical representation 700 of a detailed time course of the plurality of positions and daily time courses of real and ideal travel distances in accordance with an example embodiment of the present disclosure. FIG. 7B illustrates a graphical representation 714 of estimated daily lifespan loss that corresponds to valve position changes, in accordance with an example embodiment of the present disclosure. FIGS. 7A and 7B are described in conjunction with FIGS. 1-3.

As illustrated in FIG. 7A, the graphical representation 700 may represent the detailed time course of the plurality of positions in the predefined time period (for example (0-100%). The x-axis of the graphical representation 700 may represent the predefined time period in one week from a year (for example between 15 Apr. 2023 to 22 Apr. 2023. The y-axis of the graphical representation 700 may represent the plurality of positions of the one or more components 112, in percentage, due to fluctuations in the zone temperature. The graphical representation 700 may depict as one week of real (702) and baseline (704) positions of the one or more components 112 i.e., not daily, but with original time sampling rate.

In some embodiments, the graphical representation 700 may be an expanded view of a graphical representation 706. The graphical representation 706 may represent at least one daily real travel distance (Sᵣ) course associated with the plurality of positions in the predefined time period of a year. In some embodiments, any suitable time period may be used for representing the Sᵣ. The x-axis of the graphical representation 706 may represent the predefined time period in the year. The y-axis of the graphical representation 706 may represent at least one daily real travel distance (Sᵣ) and at least one daily baseline travel distance (S_{b}) of the one or more components 112 in the year. The graphical representation 706 may comprise a series of travel distances (Sᵣ) 712 related to the real position of the one or more components 112 causing the fluctuation of zone temperature. Further, the graphical representation 706 may comprise a series of real travel distance (Sᵣ) 708 smoothed using the centered weighted moving average window technique. Further, the graphical representation 706 may comprise a series of baseline travel distances (S_{b}) 710 smoothed using the centered weighted moving average window technique.

As illustrated in FIG. 7B, the graphical representation 714 may represent a series of estimated daily lifespan loss associated with a plurality of oscillating positions in the predefined time period. The x-axis of the graphical representation 714 may represent the predefined time period in the year. The pre-defined time period may correspond to a time period of one year. The y-axis of the graphical representation 714 may represent the lifespan loss in percentage. The graphical representation 714 may comprise a daily lifespan loss 716 related to the estimated baseline operation of the one or more components 112 of the HVAC system 104 in the predefined time period. Further, the graphical representation 714 may comprise a lifespan loss smoothed 718 related to the estimated baseline operation of the one or more components 112 of the HVAC system 104 in the predefined time period. In one example, the graphical representation 714 may indicate an oscillating valve undergoing significant wear throughout the entire one-year observation period. The oscillations lead to an estimated 89% average loss of lifespan and 89% of average energy wasted due to the oscillating valve in the depicted period.

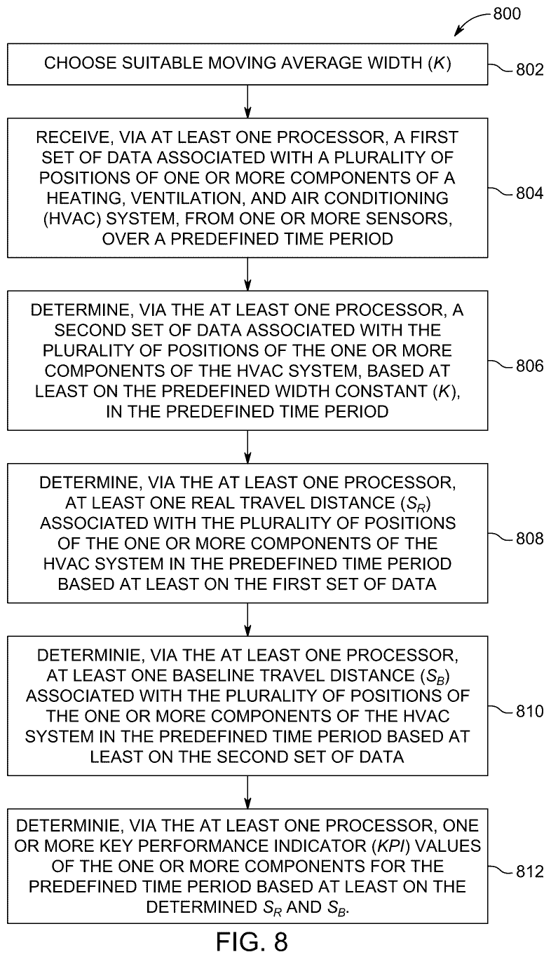

FIG. 8 illustrates a flowchart showing a method 800 for determining losses in the HVAC system 104 in accordance with an example embodiment of the present disclosure. FIG. 8 is described in conjunction with FIGS. 1-3.

At operation 802, the at least one processor 202 may be configured to choose suitable K. In an exemplary embodiment, for simplicity, weights of the centered weighted moving average window technique may be chosen to be equal. Thereafter, a simple moving average may be used. In some embodiments, proper selection of the predefined width constant (K) and a series of weights wⱼ may help to filter out oscillations in the second set of data and may not prevent the second set of data from maintaining the regulated value of the plurality of positions of the one or more components 112, at the level desired by the user.

At operation 804, the at least one processor 202 may be configured to receive the first set of data associated with the plurality of positions of the one or more components 112 of the HVAC system 104, from the one or more sensors 106, over the predefined time period. In some embodiments, the first set of data may correspond to the time series of historical data associated with the plurality of positions of the one or more components 112 of the HVAC system 104. In some embodiments, the one or more sensors 106 may comprise at least one of limit switch sensors, potentiometers, encoders, hall effect sensors, proximity sensors, ultrasonic sensors, optical sensor, and pressure sensors. Further, the one or more components 112 may comprise at least one of a valve and an air damper of the HVAC system 104.

In one example, the at least one processor 202 receives a first set of data of historical positions of valves of a complex HVAC system 104 regulating the flow of chilled water in cooling coil of Air Handling Units supplying cool air to different zones, from the one or more sensors 106 such as limit switch sensors or potentiometers. In yet another example, the at least one processor 202 receives a first set of data of historical positions of air dampers of a complex HVAC system 104 that controls the flow of conditioned air within ductwork to different zones or areas of a building through the HVAC system 104 to regulate temperature, from the one or more sensors 106 such as proximity sensors or ultrasonic sensors.

At operation 806, the at least one processor 202 may be configured to determine the second set of data associated with the plurality of positions of the one or more components 112 of the HVAC system 104, based at least on the K, in the predefined time period. In some embodiments, the second set of data may correspond to the baseline time series data associated with the plurality of positions of the one or more components 112 of the HVAC system 104. In some embodiments, the predefined time period may correspond to the monitored time period comprising at least one of hours, days, months, quarters, or years in which the first set of data is received and the second set of data is determined.

In one example, the at least one processor 202 applies a predefined width constant (K) to determine a baseline time series data of the valves' positions forming the second set of data. The baseline time series data helps to establish what the expected positions of the valves should be under normal operation. In yet another example, the at least one processor 202 applies a predefined width constant (K) to determine a baseline time series data of the air dampers' positions forming the second set of data. The baseline time series data helps to establish what the expected positions of the air dampers should be under normal operation.

At operation 808, the at least one processor 202 may be configured to determine the Sᵣ associated with the plurality of positions of the one or more components 112 of the HVAC system 104 in the predefined time period based at least on the first set of data. In some embodiments, the Sᵣ may correspond to the sum of absolute values of changes in the plurality of positions of the one or more components 112 of the HVAC system 104. In one example, the at least one processor 202 determines the Sᵣ based on the first set of data of the valves. In yet another example, the at least one processor 202 determines the Sᵣ based on the first set of data of the air dampers.

At operation 810, the at least one processor 202 may be configured to determine the S_{b} associated with the plurality of positions of the one or more components 112 of the HVAC system 104 in the predefined time period based at least on the second set of data. In some embodiments, the Sᵣ may correspond to the sum of absolute values of changes in the plurality of baseline positions of the one or more components 112 of the HVAC system 104. In one example, the at least one processor 202 determines the Sᵣ based on the second set of data of the valves. The S_{b} represents the sum of changes in valve positions over the predefined time period. In yet another example, the at least one processor 202 determines the S_{b} based on the second set of data of the air dampers. The S_{b} represents the sum of changes in air dampers positions over the predefined time period.

At operation 812, the at least one processor 202 may be configured to determine one or more KPI values of the one or more components 112 for the predefined time period based at least on the determined Sᵣ and S_{b}. In some embodiments, the K may define the width of the centered weighted moving average window technique that impacts the one or more KPI values of the one or more components 112. In some embodiments, the one or more KPI values may correspond to lifespan loss and energy loss in percentage related to estimated lifespan and consumed energy during the nominal operation of the one or more components 112 of the HVAC system 104 in the predefined time period.

In one example, the at least one processor 202 determines one or more KPI values for each valve, using the Sᵣ and the S_{b}. The one or more KPI values indicate the percentage of lifespan loss and energy wasted due to oscillations in the valves. If a valve's KPI value is 85% after a month of oscillations, it means approximately a part of the lifetime—85% of one-month long lifespan is lost, and 85% of the one-month long energy consumed by the valve is wasted.

In another example, the at least one processor 202 determines one or more KPI values for each air damper, using the Sᵣ and the S_{b}. The one or more KPI values indicate the percentage of lifespan and energy wasted due to oscillations in the air damper. If an air damper's KPI value is 89% after a month of oscillations, it means approximately a part of the lifetime—89% of one-month long lifespan is lost, and 89% of the one-month long energy consumed by the damper is wasted.

Further, if the cost of replacing a valve/an air damper is $1000, and the valve/air damper typically lasts for 12 years under normal conditions, then the estimated financial losses due to the lifespan reduction would be $472 after a year of oscillations. The losses continue to accumulate if the oscillations persist.

In some embodiments, the system 100 may comprise at least non-transitory machine-readable information storage medium comprising one or more instructions which when executed by the at least one processor 202 to perform operations comprising receiving the first set of data associated with the plurality of positions of the one or more components 112 of the HVAC system 104, from the one or more sensors 106, in the predefined time period. In some embodiments, the first set of data may correspond to the time series of historical data associated with the plurality of positions of the one or more components 112 of the HVAC system 104. Further, the operations may comprise determining the second set of data associated with the plurality of positions of the one or more components 112 of the HVAC system 104 based at least on the K, over the predefined time period.

In some embodiments, the second set of data may correspond to the baseline time series data associated with the plurality of positions of the one or more components 112 of the HVAC system 104. Further, the operations may comprise determining the Sᵣ of the plurality of positions of the one or more components 112 of the HVAC system 104 in the predefined time period based at least on the first set of data. Further, the operations may comprise determining the S_{b} of the plurality of positions of the one or more components 112 of the HVAC system 104 in the predefined time period based at least on the second set of data. Thereafter, the operations may comprise determining one or more KPI values of the one or more components 112 for the predefined time period based at least on the determined Sᵣ and S_{b}.

The present disclosure may determine how much shorter the life of the HVAC subsystems may be because of the extra wear and tear. Firstly, by employing multiple embodiments, the system may enhance accuracy and reliability in determining the lifespan and energy losses. Further, the utilization of sensors to gather data on component positions over a predefined time period facilitates comprehensive insights into the HVAC system dynamics. Further, the establishment of the second set of data may ensure consistency and comparability across analyses of the one or more components of the HVAC system 104. Furthermore, the determination of real travel distances (Sᵣ) based on the first set of data may enable precise measurement of system performance, and the baseline travel distances (S_{b}) may further refine the assessment, allowing for effective benchmarking. Then, the derived one or more Key Performance Indicator (KPI) values offer actionable metrics for evaluating system efficiency and identifying areas for improvement. Further, the system may promote proactive maintenance, potentially averting costly breakdowns and downtime.

The system may foster energy efficiency by pinpointing inefficiencies and optimizing system operation. Further, by facilitating data-driven decision-making, the system may empower stakeholders to make informed choices regarding HVAC investments and upgrades. Furthermore, the comprehensive analysis provided by the system may uncover previously overlooked sources of financial loss, leading to potential cost savings. Thereafter, the systematic approach by the system may enable easy integration into existing HVAC management systems, streamlining operations and enhancing overall system performance. By analyzing the one or more KPI values determined by the system, building managers may understand the economic impact of oscillations of the one or more components in the HVAC system and take corrective actions to optimize energy usage and extend equipment lifespan in the assigned HVAC system.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, a first set of data associated with a plurality of positions of one or more components of a Heating, Ventilation, and Air Conditioning (HVAC) system, from one or more sensors, over a predefined time period;
determining, via the at least one processor, a second set of data associated with the plurality of positions of the one or more components of the HVAC system, based at least on a predefined width constant (K), in the predefined time period;
determining, via the at least one processor, at least one real travel distance (Sᵣ) associated with the plurality of positions of the one or more components of the HVAC system in the predefined time period based at least on the first set of data;
determining, via the at least one processor, at least one baseline travel distance (S_{b}) associated with the plurality of positions of the one or more components of the HVAC system in the predefined time period based at least on the second set of data; and
determining, via the at least one processor, one or more Key Performance Indicator (KPI) values of the one or more components for the predefined time period based at least on the determined Sᵣ and S_{b}.

2. The method of claim 1, wherein the first set of data corresponds to a time series of historical data associated with the plurality of positions of the one or more components of the HVAC system.

3. The method of claim 1, wherein the second set of data corresponds to a baseline time series data associated with the plurality of positions of the one or more components of the HVAC system.

4. The method of claim 1, wherein the one or more sensors comprises at least one of limit switch sensors, potentiometers, encoders, hall effect sensors, proximity sensors, ultrasonic sensors, optical sensor, linear variable differential transformer (LVDT) sensors, and pressure sensors.

5. The method of claim 1, wherein the predefined time period corresponds to a monitored time period comprising at least one of hours, days, months, quarters, or years in which the first set of data is received and the second set of data is determined.

6. The method of claim 1, wherein the predefined width constant (K) defines a width of a centered weighted moving average window technique that impacts the one or more KPI values of the one or more components.

7. The method of claim 1, wherein the at least one real travel distance (Sᵣ) and the at least one baseline travel distance (S_{b}) correspond to a sum of absolute values of changes in the plurality of positions of the one or more components of the HVAC system.

8. The method of claim 1, wherein the one or more KPI values corresponds to lifespan loss and energy loss in percentage related to estimated lifespan and consumed energy during a nominal operation of the one or more components of the HVAC system in the predefined time period.

9. The method of claim 1, wherein the one or more components comprises at least one of a valve, and an air damper of the HVAC system.

10. A system comprising:
a memory; and
at least one processor communicatively coupled to the memory, wherein the at least one processor is configured to:
receive a first set of data associated with a plurality of positions of one or more components of a Heating, Ventilation, and Air Conditioning (HVAC) system, from one or more sensors, in a predefined time period;
determine a second set of data associated with the plurality of positions of the one or more components of the HVAC system, based at least on a predefined width constant (K), over the predefined time period;
determine at least one real travel distance (Sᵣ) associated with the plurality of positions of the one or more components of the HVAC system in the predefined time period based at least on the first set of data;
determine at least one baseline travel distance (S_{b}) associated with the plurality of positions of the one or more components of the HVAC system in the predefined time period based at least on the second set of data; and
determine one or more Key Performance Indicator (KPI) values of the one or more components for the predefined time period based at least on the determined Sᵣ and S_{b}.

11. The system of claim 10, wherein the first set of data corresponds to a time series of historical data associated with the plurality of positions of the one or more components of the HVAC system.

12. The system of claim 10, wherein the second set of data corresponds to a baseline time series data associated with the plurality of positions of the one or more components of the HVAC system.

13. The system of claim 10, wherein the one or more sensors comprises at least one of limit switch sensors, potentiometers, encoders, hall effect sensors, proximity sensors, ultrasonic sensors, optical sensors, linear variable differential transformer (LVDT) sensors, and pressure sensors.

14. The system of claim 10, wherein the predefined time period corresponds to a monitored time period comprising at least one of hours, days, months, quarters, or years in which the first set of data is received and the second set of data is determined.

15. The system of claim 10, wherein the predefined width constant (K) defines a width of a centered weighted moving average window technique that impacts the one or more KPI values of the one or more components.

16. The system of claim 10, wherein the at least one real travel distance (Sᵣ), and the at least one baseline travel distance (S_{b}) correspond to a sum of absolute values of changes in the plurality of positions of the one or more components of the HVAC system.

17. The system of claim 10, wherein the one or more KPI values corresponds to lifespan loss and energy loss in percentage related to estimated lifespan and consumed energy during a nominal operation of the one or more components of the HVAC system in the predefined time period.

18. The system of claim 10, wherein the one or more components comprises at least one of a valve, and an air damper of the HVAC system.

19. A non-transitory machine-readable information storage medium comprising one or more instructions which when executed by at least one processor to perform operations comprising:
receiving a first set of data associated with a plurality of positions of one or more components of a Heating, Ventilation, and Air Conditioning (HVAC) system, from one or more sensors, in a predefined time period;
determining a second set of data associated with the plurality of positions of the one or more components of the HVAC system based at least on a predefined width constant (K), over the predefined time period;
determining at least one real travel distance (Sᵣ) of the plurality of positions of the one or more components of the HVAC system in the predefined time period based at least on the first set of data;
determining at least one baseline travel distance (S_{b}) of the plurality of positions of the one or more components of the HVAC system in the predefined time period based at least on the second set of data; and
determining one or more Key Performance Indicator (KPI) values of the one or more components for the predefined time period based at least on the determined Sᵣ and S_{b}.

20. The non-transitory machine-readable information storage medium of claim 19, wherein the first set of data corresponds to a time series of historical data associated with the plurality of positions of the one or more components of the HVAC system, and wherein the second set of data corresponds to a baseline time series data associated with the plurality of positions of the one or more components of the HVAC system.
